(19) United States
(12) Patent Application Publication
(10) Pub. No.: US 2007/0050265 A1
(43) Pub. Date: Mar. 1, 2007

(54) Method and Apparatus for Providing a List of Items Desired to Be Purchased

(76) Inventor: Ladislav Konstacky, Lake Orion, MI (US)

Correspondence Address: GREGORY T. ZALECKI, 12900 HALL ROAD, SUITE 400, STERLING HEIGHTS, MI, 48313, US

(21) Appl. No.: 11/558,919

(22) Filed: Nov. 12, 2006

(51) Int. Cl. G06Q 30/00

(52) U.S. Cl. 705/26

(57) ABSTRACT

A method for providing across the Internet a list of items desired to be purchased by one or more buyers to a seller. Buyer related information is recorded into a buyer database. Items wanted related information is recorded into an items wanted database. The database records are populated by information received across the Internet. An items wanted search request is received from the seller. The items wanted database is filtered into a set of records satisfying the search request. The filtered set of records is translated for transmission and display across the Internet. The seller is provided with the translated filtered set of records by way of an Internet transmission. Thus, a seller can receive a selective list of items desired to be purchased by a buyer. This method is implemented by an appropriately programmed computer connected to the Internet.

### BACKGROUND

The Internet is commonly used to facilitate commerce. It is used to bring buyers and sellers together to enter into sales transactions. Many web sites exist which specialize in finding buyers for specific types of goods and services. For example, web sites exist wherein sellers can list automobiles, real estate and vacation homes for sale or rent. Others, such as eBay, permit sellers to list an almost endless variety of goods and services for sale.

Typically, these web sites are owned and operated by a profit-making entity. Sellers list items which they desire to sell by providing information to the web site operator. Prospective buyers connect to the web site by way of the Internet. They indicate to the web site operator a description of the goods or services desired to be purchased. The web site automatically searches its records to find goods and services which satisfy the search criteria. A listing of goods or services which satisfies the search criteria is provided to a prospective buyer by way of an Internet transmission to the buyer. A sales transaction between a buyer and a seller is thus facilitated. The sales transaction can be facilitated by providing the buyer with contact information for directly contacting the seller. The transaction can also be facilitated by an automated auction process conducted by the web site. Bids for goods or services desired to be sold are automatically accepted by the web site and a winning bidder is automatically selected. Information is then provided to the seller and the successful bidder sufficient to allow completion of the sales transaction.

None of the web sites provide lists of goods or services desired to be purchased by buyers to sellers. They provide lists of goods or services desired to be sold by sellers to buyers.

What is needed is an Internet service which would permit people who want to buy something in particular to communicate this information to prospective sellers. Thus, a buyer could post an interest in buying goods or services of a certain description; the buyer would not need to browse through voluminous sales listings. The needed Internet service would entail the creation of a web site. The web site would list and categorize buyers who want to buy a wide variety of items such as automobiles, boats, furniture, homes, collectibles, art, etc. It would give sellers an opportunity to browse through the listings and find a buyer for their item immediately, before they have to pay a fee to list it on a “seller's” web site. Buyers would list their items for a relatively low fee. This fee could be paid by a credit card. It would be for specific period of time such as one month. The buyer would answer a few simple questions to help categorize the item. The buyer would also provide geographical information, such as a zip code, relating to the location of the buyer. The seller would search the listings and contact potential buyers through an e-mail message. After the purchase has been made, the buyer would be able to cancel the listing immediately. If needed, the buyer could also extend the listing for another period of time, such as one month. The web site would be placed on the World Wide Web for use by millions of customers. It would require a great deal of initial advertising, because it is not a common thing for buyers to advertise, except for a limited number of advertisements in local newspapers. The described needed Internet service this invention is encompassed within this invention.

### SUMMARY

This invention is a method and apparatus for providing a list of at least one item desired to be purchased by at least one buyer to a seller. Buyers provide information relating to items desired to be purchased. This information is selectively communicated to sellers based upon search criteria provided by the sellers. A buyer database is created for recording buyer related information. An items wanted database is created for recording items wanted information. One or more buyer database records are created by recording buyer related information received from at least one buyer into the fields of at least one buyer database record. One or more items wanted database records are created by recording item wanted related information received from at least one buyer into the fields of at least one items wanted database record. Optionally, a seller database is created for recording seller related information. Also optionally, one or more seller database records are created by recording seller related information received from at least one seller into the fields of at least one seller database record. An items wanted database search request is received from a seller. The search request contains information related to an item which the seller desires to sell. The items wanted database is filtered into a set of records satisfying the search request. The filtered set of records is translated such that the set of records is suitable for transmission and display across the Internet. For example, the filtered set of records may be translated into a hypertext markup language format. The seller is provided with the translated filtered set of records by way of an Internet transmission.

The method for providing a list of at least one item desired to be purchased by at least one buyer to a seller is implemented by an apparatus for providing a list of at least one item desired to be purchased by at least one buyer to a seller. The apparatus is comprised of a computer, a writable and readable storage device containing databases and a plurality of processes executing on the computer. The computer is operationally connected to the Internet. The writable and readable storage device is operationally connected to the computer. Preferably, the storage device is a computer hard drive. A buyer database is stored on the storage device for recording buyer related information. An items wanted database is stored on the storage device for recording items wanted related information. A process is executed on the computer for creating one or more buyer database records by recording buyer related information received from at least one buyer into the fields of at least one buyer database record. A process is executed on the computer for creating one or more items wanted database records by recording item wanted related information received from at least one buyer into the fields of at least one items wanted database record. A process is executed on the computer for receiving an items wanted database search request containing information related to an item which the seller desires to sell. A process is executed on the computer for filtering the items wanted database into a set of records satisfying the search request. A process is executed on the computer for translating the filtered set of records such that the set of records is suitable for transmission and display across the Internet. A process is executed on the computer for providing the seller with the translated filtered set of records by way of an Internet transmission.

### DRAWINGS

These and other features, aspects, and advantages of the present invention will become better understood with regard to the following description, appended claims, and accompanying drawings where:

FIG. 1 is a flowchart of a method for providing a list of at least one item desired to be purchased by at least one buyer to a seller.

FIG. 2 is a perspective view of an apparatus for providing a list of at least one item desired to be purchased by at least one buyer to a seller.

FIG. 3 is a depiction of a buyer database.

FIG. 4A and FIG. 4B depict an items wanted database. FIG. 4A is the left side and FIG. 4B is the right side.

FIG. 5 is a depiction of a seller database.

FIG. 6 is a form for recording buyer related information into a buyer database.

FIG. 7 is a form for recording item wanted related information into an items wanted database.

FIG. 8 is a form for recording seller related information into a seller database.

FIG. 9A and FIG. 9B show a database query for filtering an items wanted database based upon category information. FIG. 9A is the left side and FIG. 9B is the right side.

FIG. 10A and FIG. 10B show a database query for filtering an items wanted database based upon description information. FIG. 10A is the left side and FIG. 10B is the right side.

FIG. 11 is a set of records filtered by category information.

FIG. 12 is a set of records of filtered by description information.

### DESCRIPTION

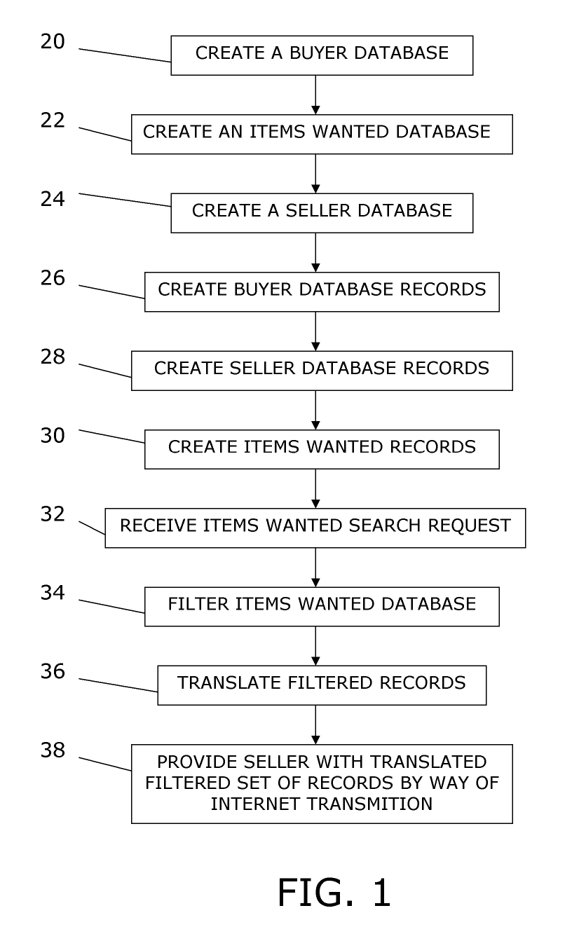

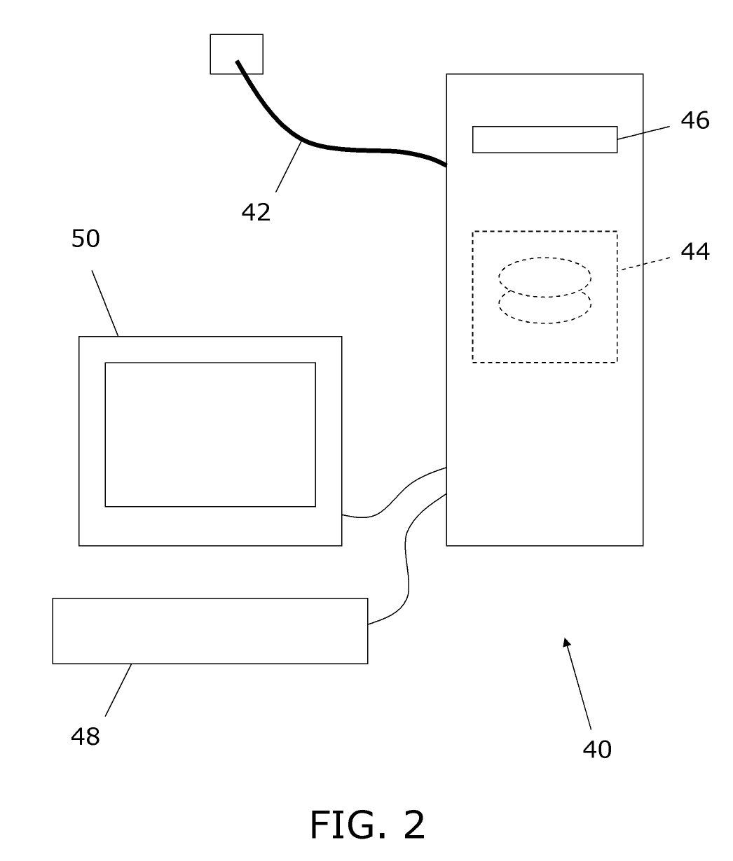

A method for providing a list of items desired to be purchased by a buyer to a seller is depicted in a flowchart format in FIG. 1. The first step 20 shown in the flowchart is the creation of a buyer database 52. A database is a collection of data arranged for ease and speed of search and retrieval. Database software for use on a computer is commonly available. One popular and powerful database program is sold under the trade name Microsoft Access. Microsoft Access encapsulates tables, queries, forms, reports, macros and modules into one database. When the term database is used herein to refer to a single set of records it should be understood that this single set of records is known in Microsoft Access as a table. Thus, the terms buyer database, items wanted database and seller database referred to within the summary section would more appropriately be denominated buyer table, items wanted table and seller table in a Microsoft Access context. Other database programs, such as SQL, may be used to implement the method described.

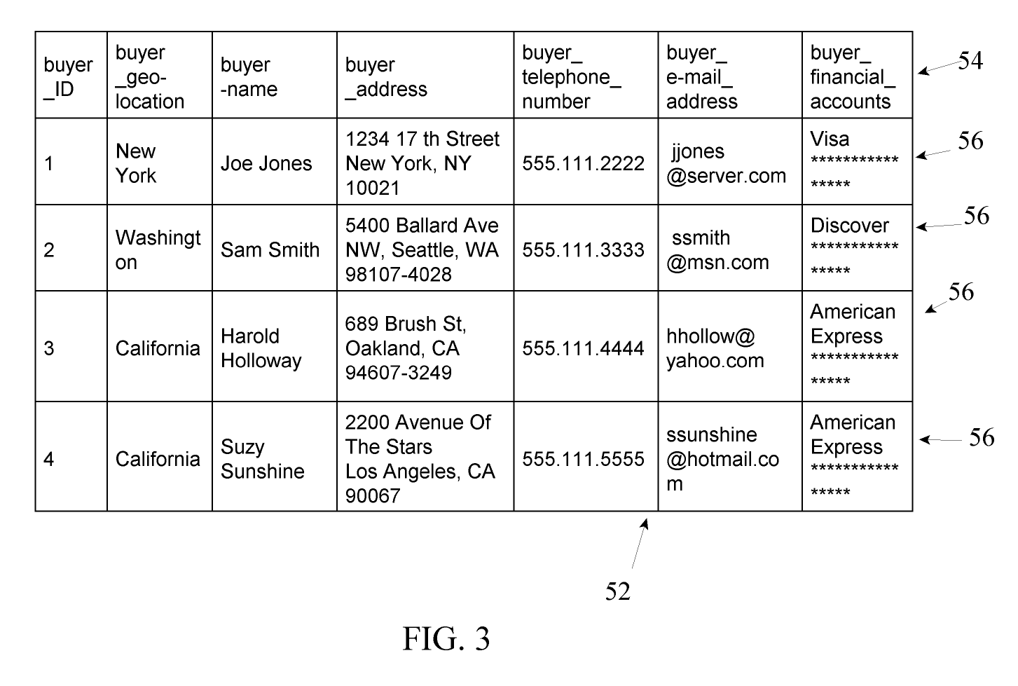

The buyer database 52 is set up to record buyer related information. Preferably, the buyer database 52 has the following buyer database fields 54: buyer ID, buyer geographical location, buyer name, buyer address, buyer telephone number, buyer e-mail address and buyer financial account. A field is an element of a database record in which one piece of information is stored. FIG. 3 is a depiction of a buyer database 52. Typically databases are depicted as tables having rows and columns. The first row contains headings which are field names 54. The subsequent rows are database records 56. Each record contains information for each field. In the buyer database 52 the buyer ID field uniquely identifies each buyer. Preferably, the buyer ID field contains numerical data to allow quick data entry and to facilitate sorting and searching. The buyer geographical location field is a text field indicating where the buyer is located. It can contain city, state or ZIP code information. It allows a seller to learn the geographical location of a buyer. The buyer name field is a text field. It contains the buyer's name. The buyer address field is a text field. It contains the buyer's address. The buyer telephone number field contains the buyer's telephone number. The buyer e-mail address field contains the buyer's e-mail address. The buyer financial account field contains information, such as credit account numbers, related to intended modes of payment for the buyer. If a transaction is consummated, the buyer financial account information may be used to facilitate payment to a seller. The buyer telephone number, buyer e-mail address and buyer financial account fields are text fields. Optionally, the buyer financial account field may be a numerical field. The buyer database fields 54 may be subdivided into additional fields. For example, the buyer address field may be subdivided into street address, city, state and zip code fields. The fields should be subdivided based upon intended search criteria. If the buyer database 52 is expected to be searched based upon area code, then the buyer telephone number should be divided into area code and local telephone number fields.

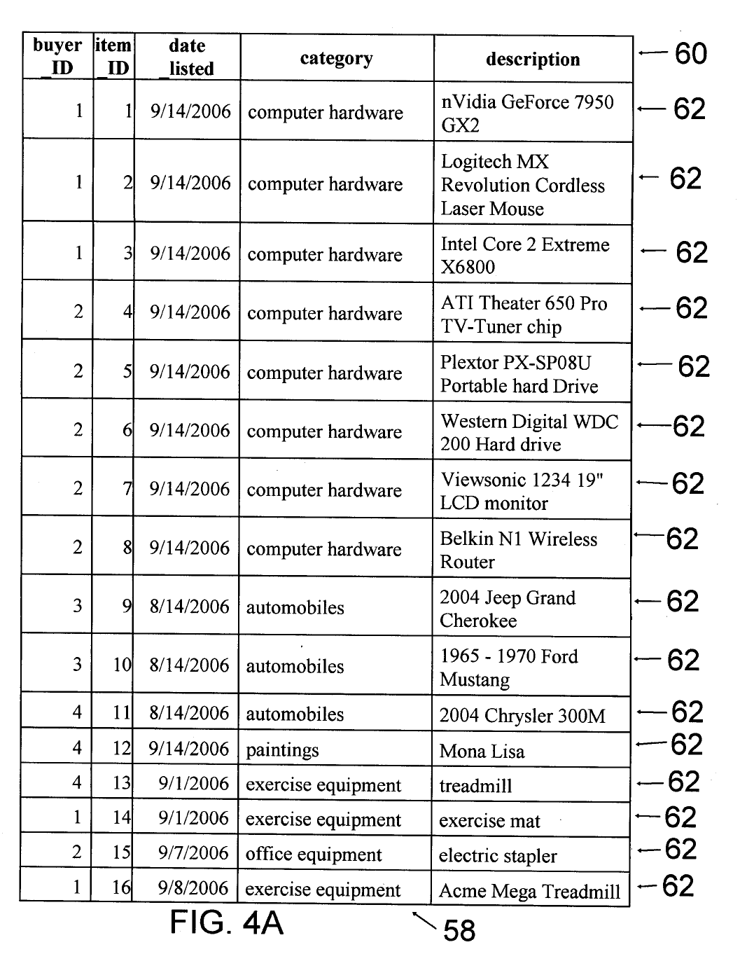

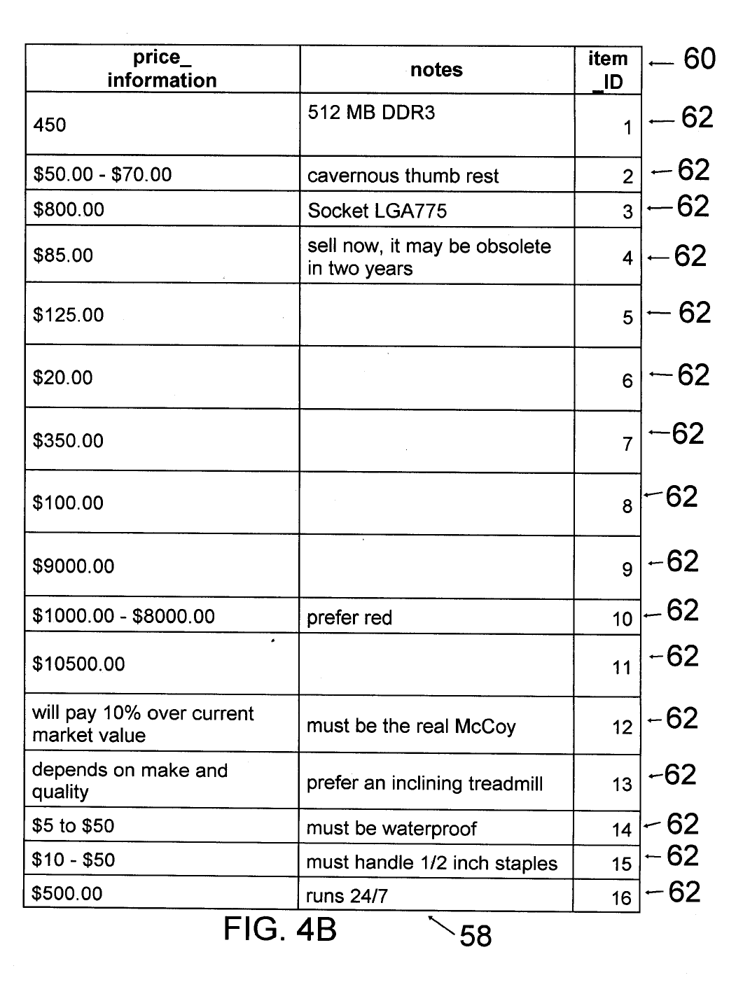

The next step 22 shown in the flowchart is the creation of an items wanted database 58. The order of the creation of the databases 52, 58 and 64 is not mandatory. The items wanted database 58 is set up to record items wanted related information. Preferably, the items wanted database 58 has the following items wanted database fields 60: item ID, buyer ID, date listed, category, description and price information. Optionally, the items wanted database 58 also has a notes field. The buyer ID field identifies the buyer with respect to each items wanted record 62. In a relational database system it is used to link to a corresponding field in the buyer database 52. The item ID field uniquely identifies each item wanted. Preferably, the item ID field contains numerical data to allow quick data entry and to facilitate sorting and searching. The date listed field contains the date that an item was listed for sale. This field may be subdivided to contain a listing expiration date. Subdivision of a field means adding one or more additional related fields. The category field contains information categorizing an item wanted to facilitate searching and sorting the database. For example, the first eight records of the items wanted database 58 depicted in FIG. 4A and FIG. 4B contain the words “computer hardware” within the category field, while the description fields all differ. The description field contains information describing the item wanted with respect to each items wanted database record 62. The price information field contains information regarding the price that a buyer is willing to pay for the item described. It can contain a specific monetary amount, a range of monetary amounts or other information expressing the price that a buyer is willing to pay. The notes field contains miscellaneous information relating to the item wanted which is not logically consistent with the other fields. The date listed field should be a date field. The category, description and notes fields should be text fields. The price information field can be a numerical or a text field.

FIG. 4A and FIG. 4B show a typical items wanted database 58. The first row identifies the items wanted fields 60. The next 16 rows are items wanted database records 62.

The next flowchart entry 24 shows the optional step of creating a seller database 64. The seller database 64 is used for recording seller related information. The seller database should have the following fields 66: seller ID, seller geographical location, seller name, seller address, seller telephone number, seller e-mail address and seller financial account. The seller ID field uniquely identifies each seller. It should contain numerical data to allow quick data entry and to facilitate sorting and searching. The seller geographical location field contains information, similar to that contained within the buyer geographical location field of the buyer database, relating to the seller's geographical location. The seller address field contains the seller's address. The seller telephone number field contains the seller's telephone number. The seller e-mail address field contains the seller's e-mail address. The seller financial account field contains information relating to financial accounts, such as credit cards, which the seller may desire to use to pay for usage of the method as implemented on a web site by a web site sponsor. The seller geographical location, seller name, seller address and seller e-mail address fields should be text fields. The seller telephone number and seller financial account fields may be text fields or numerical fields. The seller database 64 fields 66 may be further subdivided as previously described.

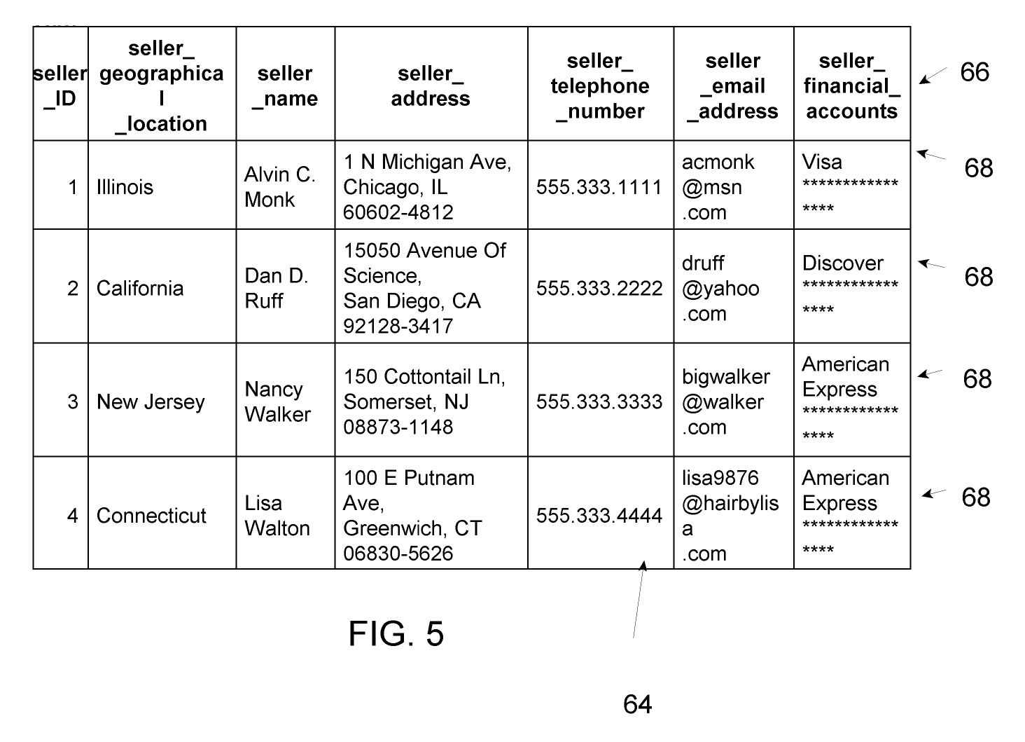

FIG. 5 shows a seller database 64. The first row contains the seller database field 66 names. The next four rows contain seller database records 68.

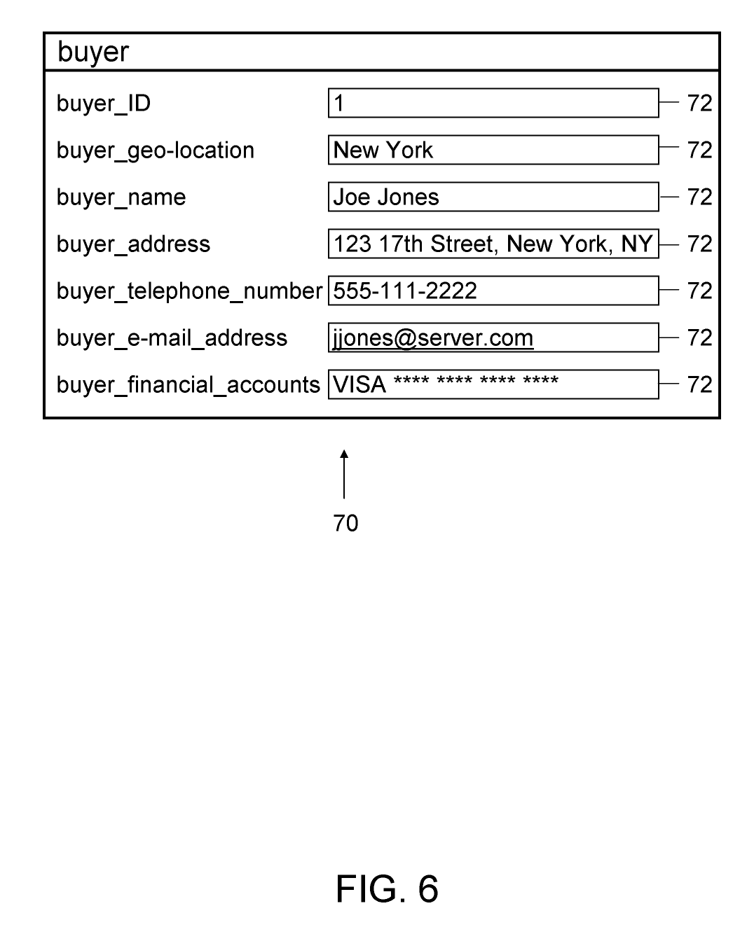

After the databases 52, 58 and 64 are created, the databases are populated with records. Buyer database records 56 are created 26. It is anticipated that the buyer database 52 will ultimately contain a large number of records. However, the method may be used so long as there is at least one buyer. The buyer database records 56 are created by recording buyer related information received from buyers into the fields of buyer database records 56. An Internet transmission may be made to a buyer which presents the buyer with a buyer input form 70, as shown in FIG. 6. The buyer input form 70 has fields for receiving buyer related information 72. The buyer related information 72 is transmitted by the buyer across the Internet to a web site implementing the method. The buyer related information 72 correlates to some, or all, of the buyer database fields 54. The buyer related information 72 is used to populate a buyer database record 56 within the buyer database 52.

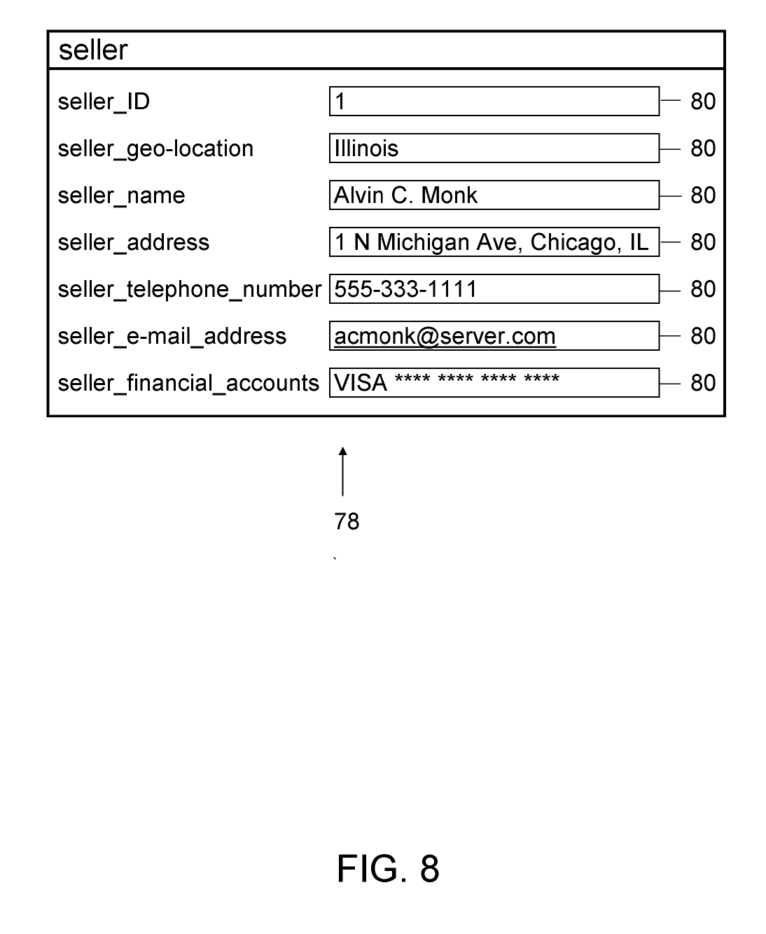

Optionally, seller database records 68 are created 28. Seller database records 68 are created by recording seller related information received from sellers into the fields of seller database records 68. An Internet transmission may be made to a seller which presents the seller with a seller input form 78, as shown in FIG. 8. The seller input form 78 has fields for receiving seller related information 80. The seller related information 80 is transmitted by the seller across the Internet to the web site implementing the method. The seller related information 80 correlates to some, or all, of the seller database fields 66. The seller related information 80 is used to populate a seller database record 68 within the seller database 64.

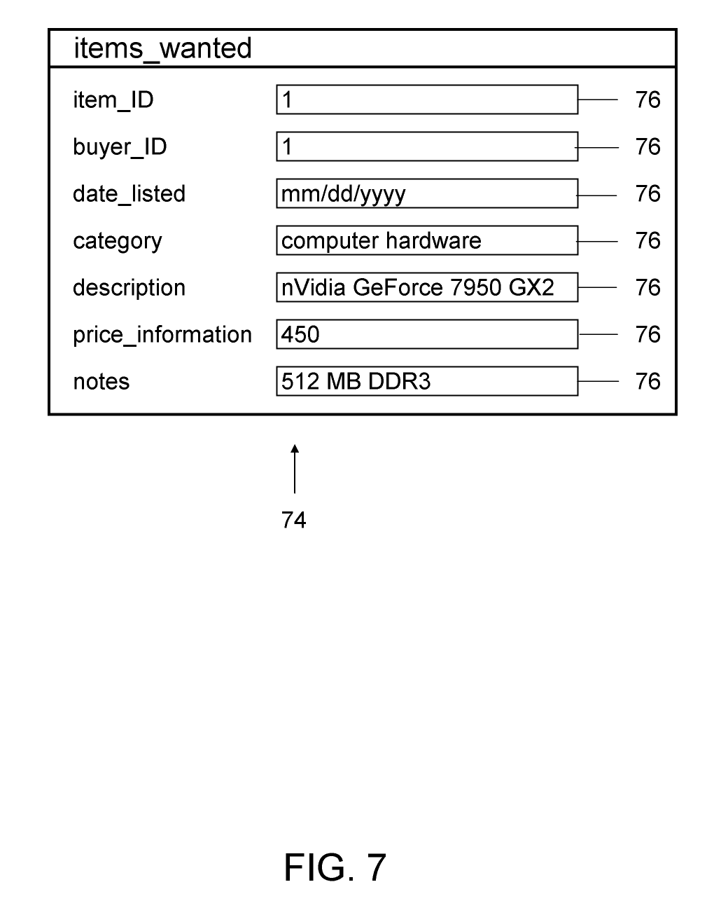

Next, items wanted database records 62 are created 30. It is anticipated that the items wanted database 58 will ultimately contain a large number of records. However, the method may be used so long as there is at least one item wanted. The items wanted database records 62 are created by recording item wanted related information received from buyers into the fields of items wanted database records 62. An Internet transmission may be made to a buyer which presents the buyer with an items wanted input form 74, as shown in FIG. 7. The items wanted input form 74 has fields for receiving item wanted related information 76. The item wanted related information 76 is transmitted by the buyer across the Internet to the web site implementing the method. The item wanted related information 76 correlates to some, or all, of the items wanted database fields 60. The item wanted related information 76 is used to populate an items wanted database record 62 within the items wanted database 58.

After the databases 52, 58, 64 have been populated with records they are ready to be searched by a prospective seller. An items wanted search request is received from a seller 32. The seller has something that he or she wishes to sell. The goal of the seller is to identify a buyer interested in purchasing the sale item. The seller interacts with the method implementing web site by way of transmissions across the Internet. The seller is provided with a search request form. The seller provides the search request and transmits it across the Internet to the method implementing web site. The search request contains information related to an item which the seller desires to sell. The seller may provide a search request based upon the category field of the items wanted database 58. For example, the seller may request that the items wanted database 58 be searched for records containing the word “automobiles” within the category field. Similarly, the seller may provide a search request based upon the description field of the items wanted database 58. For example, the seller may request that the items wanted database 58 be searched for records containing the word “treadmill” within the description field.

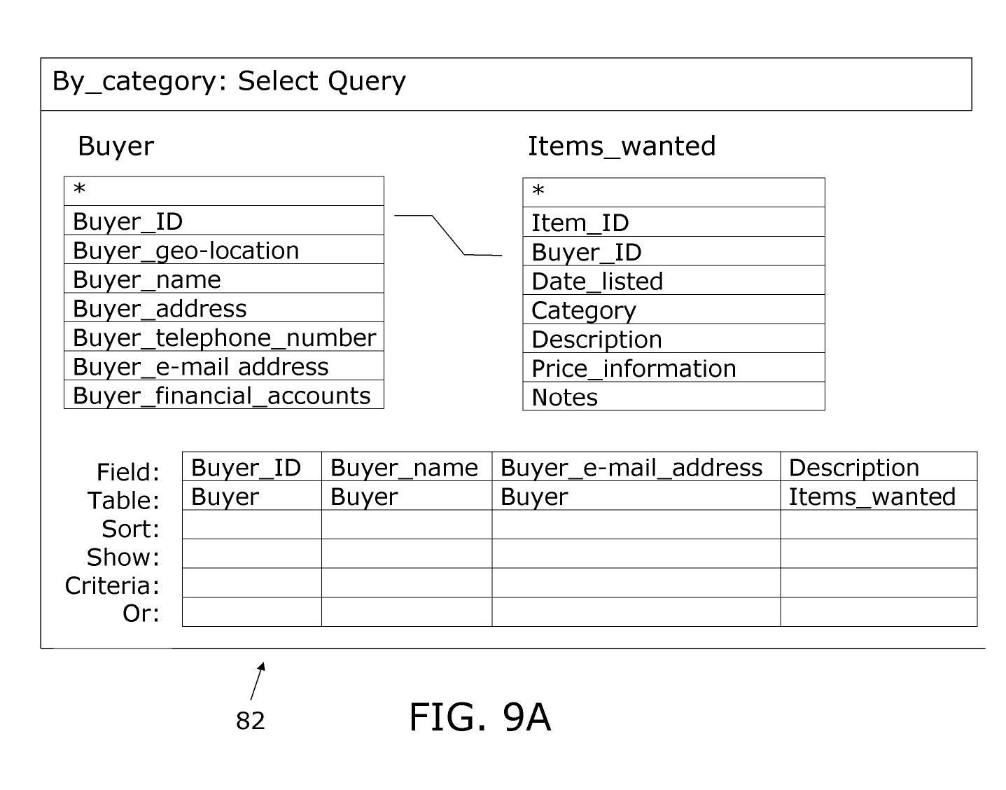

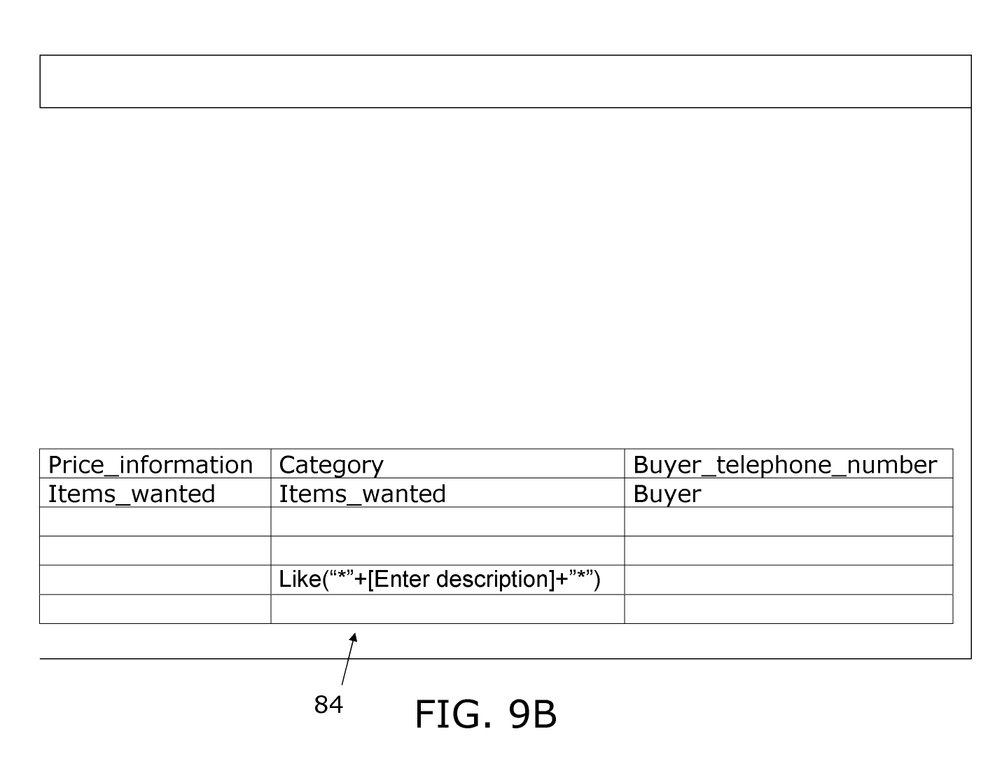

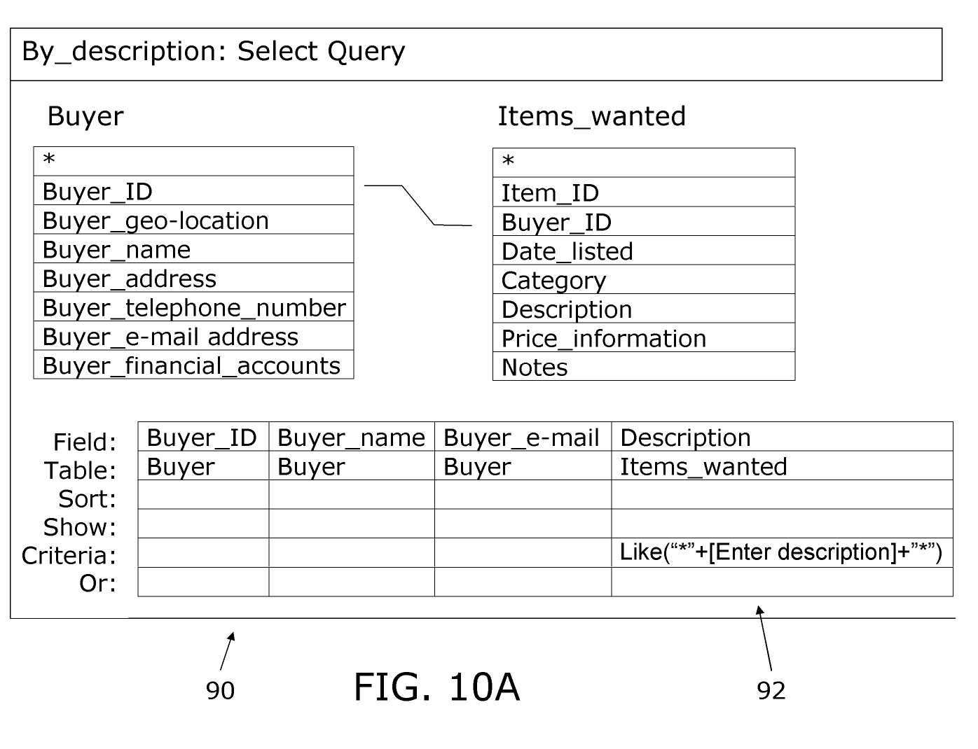

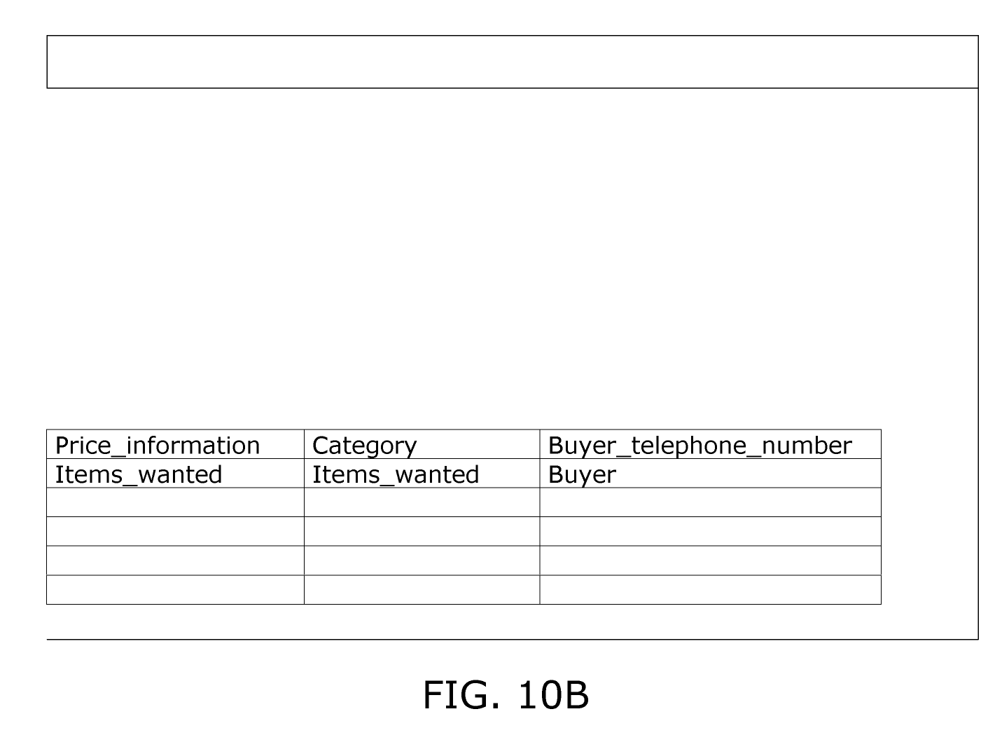

Next, the items wanted database 58 is filtered into a set of records satisfying the search request 34. Virtually all database programs provide a means for searching and filtering database records. In Microsoft Access queries are used to filter a database (called a table in Microsoft Access) into a set of records satisfying a search criteria. FIGS. 9A & 9B and FIGS. 10A & 10B show two queries which may be used to filter the items wanted database 58. For each query the buyer ID field of the buyer database 52 and the buyer ID field of the items wanted database 58 are linked. This is done so that comprehensive buyer information may be associated with each items wanted database record 62. The items wanted database 58 previously described contains a buyer ID field. However, it contains no fields relating to buyer geographical location, buyer name, buyer address, buyer telephone number, buyer e-mail address or buyer financial accounts. When the query is run it is capable of providing all of this buyer information because of the linking between the buyer ID fields of the buyer database 52 and the items wanted database 58.

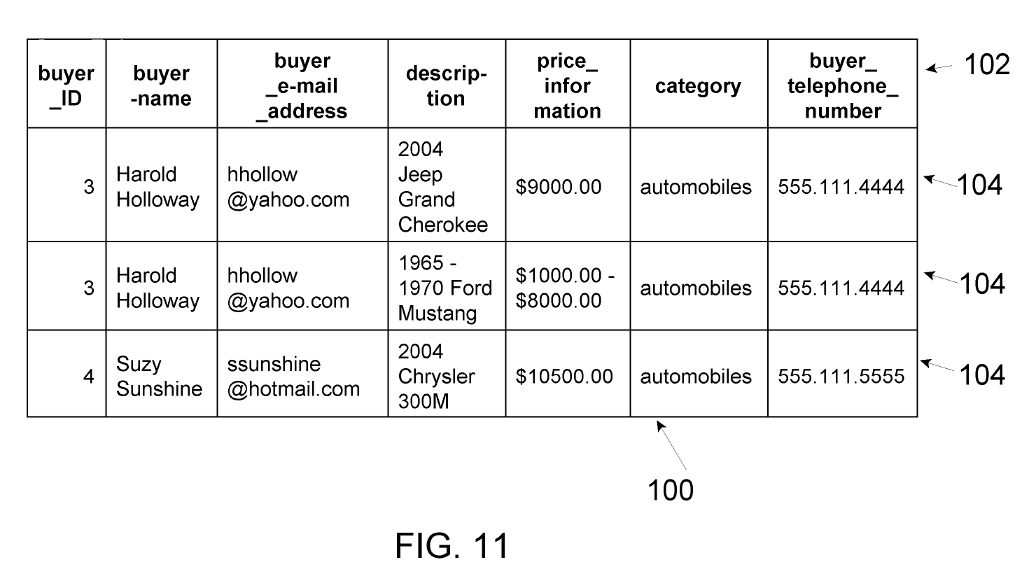

The query 82 shown in FIGS. 9A and 9B filters records based upon the category field. The search criteria 84 is: Like (“*”+[Enter description]+“*”). This searches the category field of the items wanted database 58 for a desired search phrase anywhere within the field. For example, if the items wanted database 58 of FIG. 4 is searched based upon the word “automobiles,” the filtered set of records 100 shown in FIG. 11 results. Three filtered records 104 are produced. Each filtered record 104 contains the following fields 102: buyer ID, buyer name, buyer e-mail address, description, price information, category and buyer telephone number.

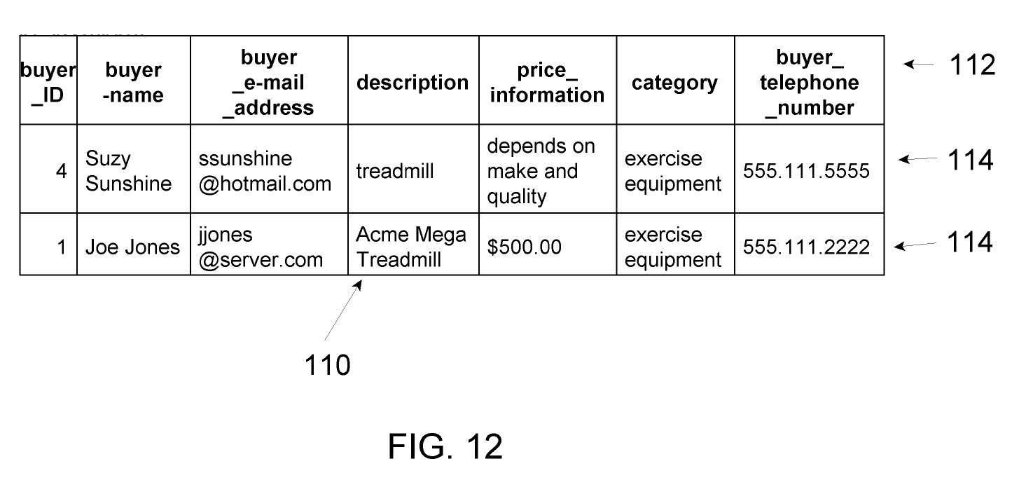

The query 90 shown in FIG. 10A and FIG. 10B filters records based upon the description field. The search criteria 92 is also: Like (“*”+[Enter description]+“*”). This searches the description field of the items wanted database 58 for a desired search phrase anywhere within that field. For example, if the items wanted database 58 of FIG. 4 is searched based upon the word “treadmill,” the filtered set of records 110 shown in FIG. 12 results. Two filtered records 114 are produced. Each filtered record 114 contains the following fields 112: buyer ID, buyer name, buyer e-mail address, description, price information, category and buyer telephone number.

Next, the filtered set of records 100, 110 is translated 36 such that the set of records is suitable for transmission and display across the Internet. The filtered set of records 100, 110 may be translated into a hypertext markup language format so that it has an appearance similar to that of FIG. 11 or FIG. 12.

The last step is to provide the seller with the translated filtered set of records by way of an Internet transmission 38. The filtered set of records 100, 110 which has been translated into a hypertext markup language format, or another suitable format, is transmitted across the Internet to the seller. The seller may then view the results of his or her search in a format similar to that shown in FIG. 11 and FIG. 12.

This invention also encompasses an apparatus for providing a list of at least one item desire to be purchased by at least one buyer to a seller. The apparatus is comprised of a computer 40 having processes executing thereon which implement the method previously described. The computer 40 is a conventional computer having a keyboard 48, a monitor 50 and a CD drive 46. It is operationally connected to a writable and readable storage device 44. Preferably, the storage device 44 is a hard drive. The computer is also operationally connected to the Internet through an Internet connection 42. The Internet connection 42 may be a network interface card which is directly or indirectly connected to the computer 40 and to the Internet. The Internet connection 42 permits communication between the computer 40 and buyers and sellers.

A buyer database 52, as described, is stored on the storage device 44 for recording buyer related information. An items wanted database 58, as described is stored on the storage device 44 for recording items wanted related information. The computer 40 is programmed so that a process can be executed upon it for creating one or more database records by recording buyer related information received from at least one buyer into the fields 54 of at least one buyer database record 56. The computer 40 is programmed so that a process can be executed upon it for creating one or more items wanted database records by recording item wanted related information received from at least one buyer into the fields 60 of at least one items wanted database record 62. The computer 40 is programmed so that a process can be executed upon it for receiving an items wanted database search request from a seller, said search request containing information related to an item which the seller desires to sell. The computer 40 is programmed so that a process can be executed upon it for filtering the items wanted database 58 into a set of records 100, 110 satisfying the search request. The computer 40 is programmed so that a process can be executed upon it for translating the filtered set of records 100, 110 such that the set of records 100, 110 is suitable for transmission and display across the Internet. The computer 40 is also programmed so that a process can be executed upon it for providing the seller with the translated filtered set of records 100, 110 by way of an Internet transmission.

Although the invention has been shown and described with reference to certain preferred embodiments and methods, those skilled in the art undoubtedly will find alternative embodiments and methods obvious after reading this disclosure. With this in mind, the following claims are intended to define the scope of protection to be afforded the inventor, and those claims shall be deemed to include equivalent constructions insofar as they do not depart from the spirit and scope of the present invention.

What is claimed is:

1. A method for providing a list of at least one item desired to be purchased by at least one buyer to a seller, said method comprising:
(a) creating a buyer database for recording buyer related information;
(b) creating an items wanted database for recording items wanted related information;
(c) creating one or more buyer database records by recording buyer related information received from at least one buyer into the fields of at least one buyer database record;
(d) creating one or more items wanted database records by recording item wanted related information received from at least one buyer into the fields of at least one items wanted database record;
(e) receiving an items wanted database search request from a seller, said search request containing information related to an item which the seller desires to sell;
(f) filtering the items wanted database into a set of records satisfying the search request;
(g) translating the filtered set of records such that the set of records is suitable for transmission and display across the Internet; and
(h) providing the seller with the translated filtered set of records by way of an Internet transmission.

2. The method for providing a list of at least one item desired to be purchased by at least one buyer to a seller of claim 1, further comprising:
(a) creating a seller database for recording seller related information; and
(b) creating one or more seller database records by recording seller related information received from at least one seller into the fields of at least one seller database record.

3. A method for providing a list of at least one item desired to be purchased by at least one buyer to a seller, said method comprising:
(a) creating a buyer database for recording buyer related information, said buyer database having buyer ID, buyer geographical location, buyer name, buyer address, buyer telephone number, buyer e-mail address and buyer financial account fields;
(b) creating an items wanted database for recording items wanted related information, said items wanted database having item ID, buyer ID, date listed, category, description and price information fields;
(c) creating one or more buyer database records by recording buyer related information received from at least one buyer into the fields of at least one buyer database record;
(d) creating one or more items wanted database records by recording item wanted related information received from at least one buyer into the fields of at least one items wanted database record;
(e) receiving an items wanted database search request from a seller, said search request containing information related to an item which the seller desires to sell;
(f) filtering the items wanted database into a set of records satisfying the search request;
(g) translating the filtered set of records such that the set of records is suitable for transmission and display across the Internet; and
(h) providing the seller with the translated filtered set of records by way of an Internet transmission.

4. The method for providing a list of at least one item desired to be purchased by at least one buyer to a seller of claim 3, further comprising:
(a) creating a seller database for recording seller related information, said seller database having seller ID, seller geographical location, seller name, seller address, seller telephone number, seller e-mail address and seller financial account fields; and
(b) creating one or more seller database records by recording seller related information received from at least one seller into the fields of at least one seller database record.

5. The method for providing a list of at least one item desired to be purchased by at least one buyer to a seller of claim 3, wherein the items wanted database has a notes field.

6. An apparatus for providing a list of at least one item desired to be purchased by at least one buyer to a seller, said apparatus comprising:
(a) a computer operationally connected to the Internet;
(b) a writable and readable storage device operationally connected to the computer;
(c) a buyer database stored on the storage device for recording buyer related information;
(d) an items wanted database stored on the storage device for recording items wanted related information;
(e) a process executing on the computer for creating one or more buyer database records by recording buyer related information received from at least one buyer into the fields of at least one buyer database record;
(f) a process executing on the computer for creating one or more items wanted database records by recording item wanted related information received from at least one buyer into the fields of at least one items wanted database record;
(g) a process executing on the computer for receiving an items wanted database search request from a seller, said search request containing information related to an item which the seller desires to sell;
(h) a process executing on the computer for filtering the items wanted database into a set of records satisfying the search request;
(i) a process executing on the computer for translating the filtered set of records such that the set of records is suitable for transmission and display across the Internet; and
(j) a process executing on the computer for providing the seller with the translated filtered set of records by way of an Internet transmission.

7. An Internet service which would permit people who want to buy something in particular to communicate this information to prospective sellers, said Internet service comprising a web site, said web site being programmed to list and categorize buyers who want to buy a wide variety of items, and said web site being programmed to give sellers an opportunity to browse through listed items to find a buyer.
